(19) United States
(12) Patent Application Publication
(10) Pub. No.: US 2004/0178537 A1
(43) Pub. Date: Sep. 16, 2004

(54) Injection molding techniques for forming a microfluidic structure having at least one flash free aperture

(76) Inventor: Quentin F. Polosky, Santa Clara, CA (US)

Correspondence Address: ACLARA BIOSCIENCES, INC., 1288 PEAR AVENUE, MOUNTAIN VIEW, CA, 94043, US

(21) Appl. No.: 10/739,721

(22) Filed: Dec. 18, 2003

Related U.S. Application Data
(63) Continuation of application No. PCT/US02/21974, filed on Jul. 10, 2002.
(60) Provisional application No. 60/304,464, filed on Jul. 10, 2001.

(51) Int. Cl. B29C 45/40; B29C 45/73

(52) U.S. Cl. 264/328.16; 264/334; 425/556; 425/577

(57) ABSTRACT

Injection molding techniques to form a microfluidic structure or substrate having at least one flash-free aperture. A method comprises injecting a polymeric material into a cavity of a mold. The mold includes at least one pin extending a length into the cavity wherein the length is greater than a depth of the cavity such that the pin is compressed when the mold is closed. Material injected into the cavity is shut off from the space occupied by the pin and consequently, undesirable flash is avoided. The mold is opened and the substrate is removed from the mold. The pin may be integral with the mold, discrete, or be comprised of individual components which can be combined together when the mold is closed to form a solid body. Preferably, the length of the pin is at least about 60 microns greater than the depth of the cavity.

### CROSS-REFERENCE TO RELATED APPLICATIONS AND PATENTS

This application claims priority to International application PCT/US02/21974 filed 10 Jul. 2002 and U.S. provisional applications Ser. No. 60/304,464, filed 10 Jul. 2001, which applications are incorporated herein by reference in its entirety

### TECHNICAL FIELD

This invention relates to injection molding techniques and in particular, to injection molding techniques for creating a microfluidic substrate having a flash free aperture.

### BACKGROUND

Microfluidic devices are increasingly being used to carry out many applications including, for example, clinical assays, high throughput screening for genomics and pharmaceutical applications, point-or-care in vitro diagnostics, molecular genetic analysis and nucleic acid diagnostics, cell separations, and bioresearch generally. Microfabricated structures allow for small volumes (e.g., pico or nanoliter size volumes) of fluids to be electrokinetically transported through interconnected channel networks and enable a range of common laboratory procedures including: mixing, incubation, metering, dilution, purification, capture, concentration, injection, separation, and detection to be performed on a single chip. These microfabricated structures allow researchers to rapidly (and in parallel) perform large numbers of bio/chemical measurements in a format that is inexpensive, miniaturized, automated, and fast.

Techniques for fabricating microfluidic devices are complicated because their features have small dimensions. For example, the diameter or height of a microchannel may range from about 1 micron to 2 mm. Any flaws or remnants resulting from the fabrication process may vitiate operation of the device.

One method for fabricating a microfluidic device is shown in FIG. 1. Referring to FIG. 1. a glass or silicon wafer 10 is masked and etched using typical wafer microfabrication processes. The etching step creates an etched glass plate 20 having, for example, a number of channels and chambers.

Next, a metal mold tool 30 is electroformed on the master wafer. This step is illustrated in FIG. 1 by reference numeral 40. As shown in steps 50 and 60, the metal mold tool is separated from the master wafer and plastic is molded or embossed using the metal mold tool. Molding may be carried out as described in, for example, U.S. Pat. No. 6,060,005 and Michaeli et al., Mass-Production Of Microstructures, Kunststoffe Plast Europe, p 27-29, v. 89, n. 9 (1999).

Step 70 indicates a molded polymeric part or substrate 75 having a channel configuration identical to the pattern etched into the master glass wafer. The channel pattern of the polymeric molded chip therefore can have micron-size channels identical to the master glass wafer. Hereinafter, polymers and polymeric materials means plastics, polymers, thermopolymers, and other materials which are capable of being formed in injection molding processes.

After molding, a cover, plate or film 80 may be bonded or applied to the polymeric substrate to enclose the channels. Bonding may be carried out by melting, fusing, annealing, application of adhesives, pressure sensitive adhesives, ultrasonic welding, or other controlled techniques to form a fluid tight seal with the channels. The plate 80 is shown on top but need not be on top. When microchannels are formed on the bottom of substrate 75, for example, the plate 80 may be bonded to the bottom of the substrate.

Conventional injection molding requires the use of elevated temperatures and high injection pressures in order to reliably and completely fill the mold cavity with a polymeric material. Under these high pressures the viscous thermoplastic or polymeric material can deflect, bend or even break core pins in the mold which are used to form through-holes. If the mold features are small, somewhat delicate, and crowded, the problem becomes accentuated. Furthermore, increased outward pressure on the mold sections can lead to separation of mold sections allowing polymeric material to flow therebetween. The resulting “flash” is a common problem and is defined as excess polymeric material that is formed with and attached to a molded product along a seam or parting line. Where the mold forms a junction or hole, this flash can cause partial or complete blockage. While small (micron-sized) amounts of flash are acceptable in many conventional molding applications, flash-free features are desired in microfluidic devices where only a small amount of flash can result in blockage. Minimal flash can also entrap bubbles which in turn inhibit fluid flow between tiny wells and channels. Furthermore, such flash is aesthetically undesirable. The parts of an injection mold must therefore be solid and durable to maintain alignment for adequate molding. For this reason, conventional injection molding techniques are problematic and undesirable.

One alternative to molding features in the base substrate of a microfluidic device is to utilize machining techniques to create the desired features. For example, apertures or though-holes may be drilled after the injection molding step. Various machining techniques may be employed as is known in the art to create through holes, wells, channels and other features in microfluidic structures. However, it has been found that many of these conventional machining techniques, such as drilling, leave undesirable remnants, requiring deburring or cleanup. Drilling and deburring require additional time and personnel to carry out. Drilling is thus not a cost effective alternative to directly molding through-holes in microfluidic substrates.

Accordingly, there is a continuing need for a microfluidic device molding technique which does not suffer from the above mentioned drawbacks. Among other things, this means that the improved technique should be replicable while consistently forming microfluidic substrates which include one or more flash-free through-holes wherein formation of the through-holes does not require additional machining or processing steps.

### SUMMARY OF THE INVENTION

The present invention includes a method for molding a microfluidic structure having at least one flash free through hole. The method comprises the following steps: melting a polymeric material; injecting the polymeric material into a cavity formed by at least a first mold section and a second mold section engaged to the first mold section; cooling the polymeric material while the material is in the cavity to form the substrate; separating the first mold section from the second mold section; and removing the substrate from one of the first mold section and the second mold section wherein the first mold section includes at least one pin extending a length into the cavity and wherein the length is greater than a depth of the cavity such that melted polymeric material flows around the at least one pin to form a flash-free through-hole in the substrate.

When the mold sections are brought together, the pins are compressed or loaded thereby providing a “shutoff” region. By shut-off it is meant that polymeric material injected into the mold cavity is prevented from flowing between two interfacing mold sections thereby preventing flash. In addition to providing shutoff, loading the pins makes them more rigid allowing them to withstand any deflection, bending or breakage caused by the high pressure injection of polymeric materials into the mold cavity.

The at least one pin may be discrete or integral with the first mold section. Preferably, the pin is a metal pin press fit into an opening in the first mold section. The length of the pin is greater than the depth of the cavity by about 10 to 100 microns, preferably 30 to 80 microns, usually about 60 microns.

In a variation of the present invention, a method for forming a substrate comprises: melting a polymeric material; injecting the polymeric material into a cavity having a depth, said cavity formed from at least a first mold section and a second mold section positioned against the first mold section wherein the first mold section comprises a first body extending into the cavity and the second mold section comprises a second body extending into the cavity such that the first body and the second body contact one another when the first mold section and the second mold section are positioned together to form the cavity and wherein polymeric material injected into the cavity is shut off from space occupied by the first body and the second body such that the at least one flash-free through-hole is formed in the substrate. The first body and the second body combine to form a length greater than the depth of the cavity when the cavity is formed. The length may be greater than the depth of the cavity by about 10 to 100 microns, preferably 30 to 80 microns, usually about 60 microns.

In another variation of the present invention, an injection molding assembly for forming a substrate comprises: a first mold section; a second mold section adapted to engage the first mold section such that a cavity having a depth is formed therebetween when the first mold section is engaged with the second mold section; and at least one pin extending a length from at least one of the first mold section and the second mold section into the cavity wherein the length is greater than the depth of the cavity such that when melted polymeric material is injected into the cavity the melted polymeric material flows around the at least one pin to form a flash-free through-hole in the substrate. The at least one pin may be discrete or integral with the first mold section. Preferably, the pin is a steel pin press fit into an opening in the first mold section. The length of the pin is preferably greater than the depth of the cavity by about 10 to 100 microns, preferably 30 to 80 microns, usually about 60 microns. The first mold section may comprise an electroformed portion having raised surfaces to form microchannels and/or shutoff regions in the substrate.

In another variation of the present invention, an injection molding assembly for forming a substrate of a microfluidic device comprises: a first mold section; a second mold section adapted to engage the first mold section such that a cavity having a depth is formed therebetween when the first mold section is engaged with the second mold section; and at least one pin extending from the first mold section and at least one pin extending from the second mold section into the cavity such that the at least one first pin and the at least one second pin contact one another when the first mold section and the second mold section are positioned together to form the cavity and wherein polymeric material injected into the cavity is shut off from space occupied by the at least one first pin and the at least one second pin such that at least one flash-free through-hole is formed in the substrate. The at least one first pin and the at least one second pin combine to form a length greater than the depth of the cavity when the cavity is formed. Preferably, the length is about 10 to 100 microns, preferably 30 to 80 microns, usually about 60 microns. The first mold section may comprise an electroformed portion having raised surfaces to form microchannels in the substrate.

In a variation of the present invention, the pin extending from the first mold section is designed such that it compresses when the mold is closed. Alternatively, or in addition to, the pin extending from the second mold section may be designed such that it compresses when the mold is closed. The degree of compression is affected by, amongst other factors, the length, width, diameter and material of the pins.

In another variation of the present invention, a substrate of a microfluidic device includes at least one flash-free aperture. The substrate is produced by the process comprising: providing an openable mold having a cavity therein. The mold further includes a plurality of pins extending a length into the cavity wherein the length is greater than a depth of the cavity such that the pins are compressed when the mold is closed. The process additionally includes injecting a material into the cavity such that the material fills the cavity but is shut off from the space occupied by the pins to form a flash-free through-hole in the substrate. The process further includes opening the mold and removing the substrate from the mold. Each of the pins may be comprised of two opposing bodies, each of the pins may be a discrete body, or each of the pins may be integral with the mold. Preferably, the length of the pins is greater than said depth of the cavity by about 10 to 100 microns, preferably 30 to 80 microns, usually about 60 microns. The mold may comprise an electroformed portion having raised surfaces to form the at least one microchannel and/or shutoff regions.

In another variation of the present invention, a microfluidic device comprises a substrate comprising at least one flash-free aperture produced by any one of the above mentioned methods. The device further comprises a plate bonded to the substrate such that a reservoir is formed at the at least one flash-free aperture. The microfluidic device may also comprise a plurality of reservoirs in fluid communication with one another via at least one microchannel.

### BRIEF DESCRIPTION OF THE DRAWINGS

FIG. 1 is an illustration of a fabrication process for forming microfluidic devices.

FIG. 2A is a perspective view of a microfluidic device in accordance with the present invention; the microfluidic device shown in FIG. 2A includes a substrate having two flash-free through-holes and a cover plate bonded to the substrate.

FIG. 2B is a cross-sectional view of the microfluidic device shown in FIG. 2A taken along A-A.

FIGS. 3A and 3B are partial sectional views of an injection molding assembly in an open and closed position respectively in accordance with the present invention.

FIG. 4A is an enlarged partial sectional view of an open mold having a pin in accordance with the present invention.

FIG. 4B is an enlarged partial sectional view of a closed mold having a compressed pin in accordance with the present invention.

FIG. 5A is an enlarged partial sectional view of an open mold having a short pin and a long pin opposed to the short pin in accordance with the present invention.

FIG. 5B is an enlarged partial sectional view of a closed mold having a short pin and a long pin in contact with one another in accordance with the present invention.

FIG. 5C is an enlarged side view of a short pin and a long pin in contact with one another in accordance with the present invention.

FIG. 6 is an illustration of a flash-free through-hole having a step in accordance with the present invention.

FIGS. 7A and 7B are illustrations of a flash-free through-hole in accordance with the present invention viewed from the A-side and the B-side respectively.

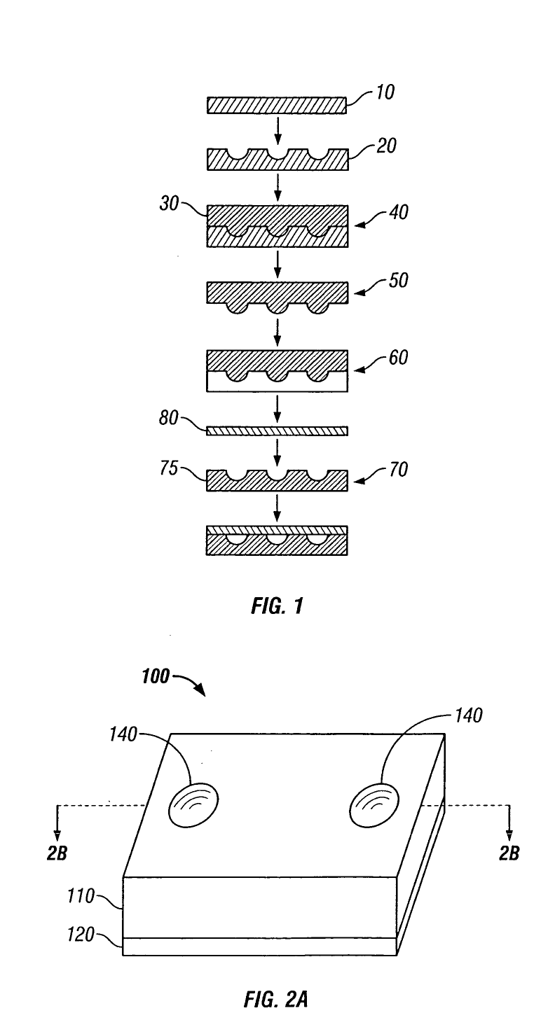

### DETAILED DESCRIPTION

The present invention is directed to injection molding techniques for forming component substrates in microfluidic devices. In particular, the present invention provides a method and assembly to produce a base or substrate having flash-free through-holes. The method includes injecting polymeric material into a cavity formed by a mold. The mold includes at least one pin extending a length into the cavity wherein the length of the pin is greater than the depth of the cavity such that the pins are compressed when the mold is closed. Polymeric material injected into the cavity is thus “shut off” from the space occupied by the pins and flash is prevented from seeping between the pin surface to contact the mold and the mold. In addition, the loaded pins are more rigid making them resistant to deflection, bending, or breakage during the molding process. Other variations of the above described invention are disclosed hereinafter and other variations will become apparent upon reading the following description in conjunction with the accompanying drawings.

Microfluidic Devices

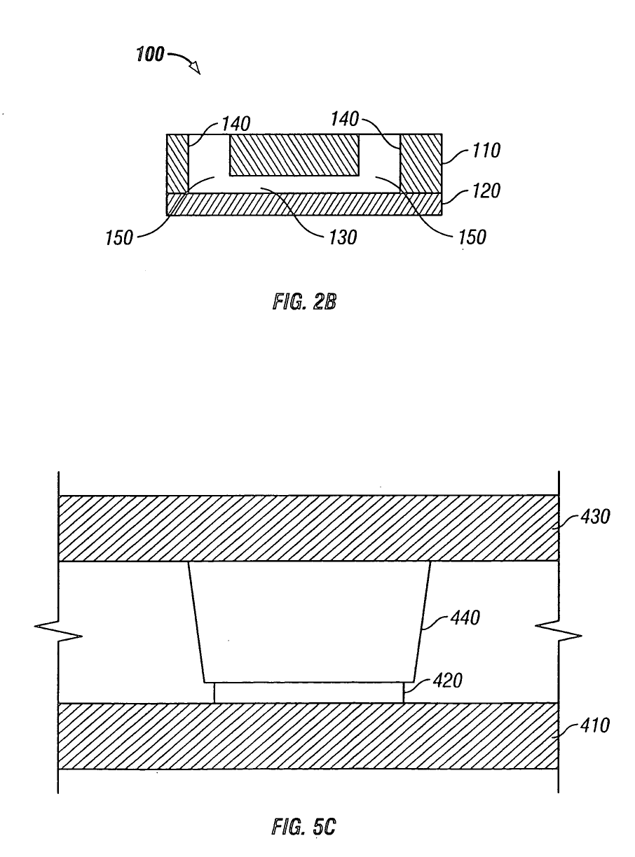

An example of a microfluidic device 100 in accordance with the present invention is shown in FIGS. 2A and 2B. The microfluidic device shown in FIGS. 2A and 2B is not to scale and is intended to illustrate structure which may be difficult to recognize if drawn to scale. In particular, the size of microchannel 130 relative to the thickness of the device is exaggerated.

Typically, the microfluidic device 100 will include a substrate 110 and a plate 120 bonded to the substrate 110. While the substrate is shown in the figures as a rectangular plate, the substrate may take a variety of different shapes including disc-like or other shapes. The substrate is not limited to being positioned on top but may be positioned on the bottom of the microfluidic device or centrally positioned in the microfluidic device such as in a sandwich configuration. Examples of microfluidic structures are described in, for example, U.S. Pat. Nos. 5,750,015 and 6,033,546. All publications, patent applications, patents, and other references mentioned in this application are incorporated by reference in their entirety. To the extent there is a conflict between this application and another patent (or reference) incorporated by reference, this application will control.

The substrate 110 typically features at least one generally planar surface having one or more microchannels 130 and one or more apertures or through-holes 140 in fluid communication with the microchannels. Wells or reservoirs 150 are formed at the through-holes 140 when the plate 120 is bonded to the substrate as shown in FIG. 2B.

In one variation, a cover or film is bonded to the bottom of the substrate thereby enclosing and sealing the microchannels. Access to the channels is provided via through holes in the substrate.

The cover 120 may or may not include one or more microchannels and apertures. A cover having one or more apertures and microchannels may be molded using methods disclosed hereinafter. The cover 120 may be a more or less rigid plate, or it may be a film. The thickness of the cover 120 may be different for materials having different mechanical properties. Usually the cover ranges in thickness from at least about 200 microns, more usually at least about 500 microns, to as thick as usually about 5 mm or thicker, more usually about 2 mm. The cover may be fabricated from a single material or be fabricated as a composite material. The cover may comprise glass or a polymeric material, and it may be rigid or elastomeric. Suitable materials for the cover and substrate include but are not limited to polymers such as acrylics, polycarbonate (PC), polystyrenes, noncyclic and cyclic polyolefins such as polynorbornenes, and other polymers which are suitable for molding or forming.

Any of a variety of microchannel patterns, device shapes, and substrate materials can be used to construct and assemble the components of the microfluidic systems according to the invention, so long as the material of the substrate is capable of being injected into a cavity of mold, as described further below.

The substrate and cover plate may be assembled by direct bonding. For example, a polymeric film may be bonded to a polymeric substrate by thermal diffusion bonding. Alternatively, an adhesive layer such as a pressure sensitive adhesive may be disposed between the cover and the base substrate. The adhesive layer can bond, for example, a polymeric base substrate to a glass cover plate. Or, the device can be formed as a laminate (sandwich structure).

In operation, fluids and samples are added to one or more of the reservoirs 150 and are electrokinetically (or otherwise) driven through the microchannels 130 to carry out various biochemical processes such as those mentioned above. Types of microfluidic applications and mechanisms for manipulating fluids through the various channels are described in a number of patents including, for example, U.S. Pat. Nos. 5,858,187 and 6,010,607.

Injection Molding Assemblies

The present invention provides a technique for fabricating an improved microfluidic device. In particular, the present invention provides an injection molding technique which provides microfluidic structures having flash-free through-holes or apertures. The injection molding technique comprises melting a polymeric material; injecting the polymeric material into a cavity of mold; cooling the mold to form the article; and removing the article from the mold.

Examples of injection molding machines which may be used to carry out the present invention include Roboshot 110i by Cincinnati Milacron, Engel ES 150 machine. Preferably, the injection molding machine is capable of controlling and varying certain molding parameters such as temperature during the molding cycle. For example, it may be desirable to raise the temperature of one or more of the mold sections above the softening point of the injected polymer before or during injection. The temperature of the mold sections may also be raised after injection. One example of an injection molding method is described in U.S. Pat. No. 6,060,005.

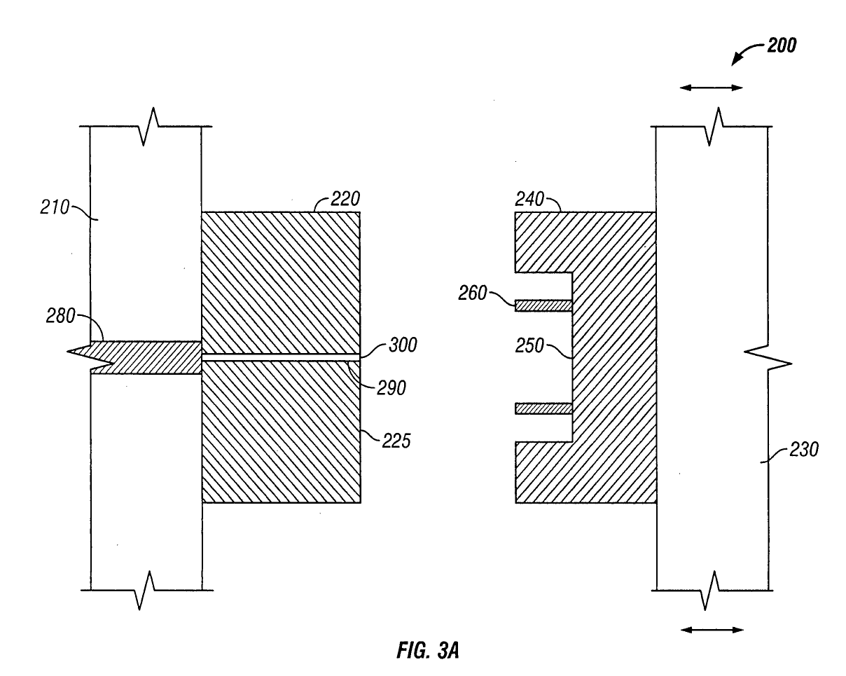

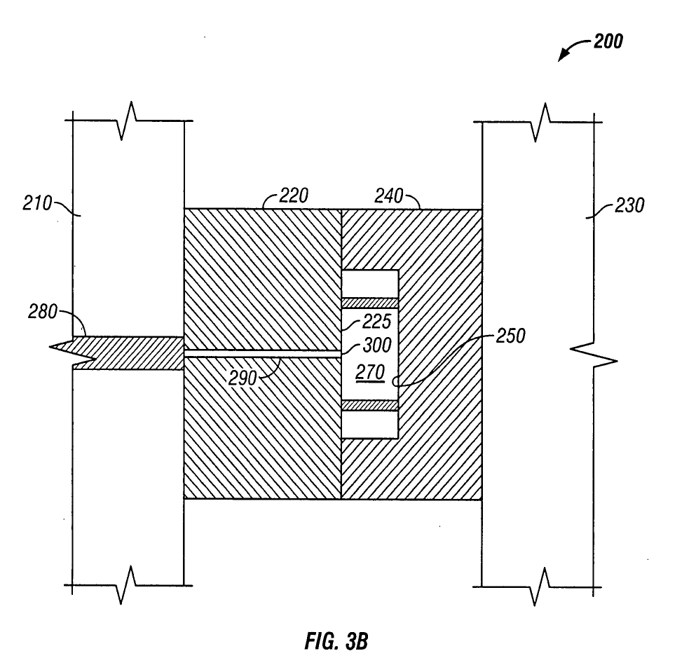

To carry out the above recited process, the present invention employs a novel injection molding assembly. An exemplary injection molding assembly is illustrated in FIGS. 3A and 3B. Referring to FIG. 3A, an injection molding assembly 200 includes a first platen 210 supporting a first mold section 220. Assembly 200 further includes a movable second platen 230 having a second mold section 240 joined thereto. Second mold section 240 includes a second mold surface 250 and two pins 260 extending therefrom. The second mold surface 250 generally includes structure (not shown) which, when the mold is closed, forms the microchannel structure in the article to be formed. This second mold surface 250 may, for example, comprise a nickel or nickel alloy electroformed region (not shown) for forming the microchannel configurations. An electroformed plate provides suitable detail and repeatability for various microchannel configurations.

The pins 260 are preferably elongated cylindrical pins with a diameter in the range of about 1 to 5 mm, more preferably 2.00 to 2.10 ±0.025 mm. One end of the pins 260 is attached to the second mold section 240 by, for example, press fitting the pins into an undersized hole (not shown) in the second mold section 240. However, other fastening methods known in the art may be employed. Further details of the pin configurations are discussed below.

In operation, the first mold section 220 is positioned against the second mold section 240 forming a cavity 270 therein (see FIG. 3B). Material such as melted polymer is injected into the cavity via a sprue 280, runner 290, and gate 300. The polymer will flow into cavity 270 and around pins 260 until the cavity is filled. To facilitate flow into the cavity, the mold sections may be temporarily heated to about the softening temperature of the polymer. Exposure to excessively high temperatures for prolonged periods will damage the polymer and should be avoided.

Microchannel configurations are thus formed in the polymer material due to structure present on second mold surface 250 and on the first mold surface 225. Further, polymer material is shut off from seeping between first mold surface 225 and the ends of pins 260 to contact the first mold surface 225 because the pins are compressed or loaded. Thus, no flash is formed in the substrate article.

Next, the mold is cooled for a time period. The time period is approximately 10 to 60 seconds. However, other time periods may be employed depending on a number of parameters including but not limited to the size of the part. Finally, the mold is opened and the part is removed typically using ejector pins built in the mold.

First Pin Variation

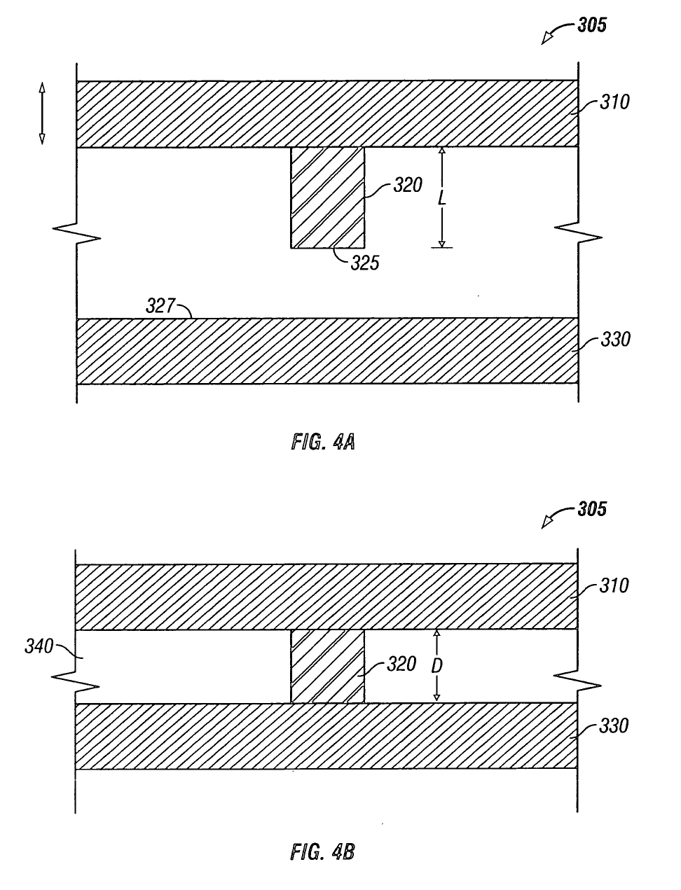

FIGS. 4A and 4B illustrate a variation of the present invention. In particular, FIG. 4A illustrates a partial sectional view of an open mold in accordance with the present invention. The mold 305 includes a first mold section 310 having a pin 320 perpendicularly extending therefrom and a second mold section 330 opposed to the first mold section. While only one pin is shown, the invention is not so limited and a plurality of pins may be attached to the first mold section. The pins may also be attached on either the first or second mold section. Further, either the first mold section, the second mold section or a combination of the two mold sections may be movable to form the cavity therebetween.

According to the assembly depicted in FIG. 4A, pin 320 is attached at a first end to first mold section 310. Pin 320 has a second free end which features a contact surface 325. When the first mold section and the second mold section are positioned together to form a sealed cavity 340 (shown in FIG. 4B), the surface 325 contacts a second mold surface 327 of second mold section 330. The pin's contact surface 325 is preferably ground flat and parallel to the second mold surface 327 of second mold section 330. Conventional machining techniques are suitable to achieve the flatness and parallelness required by the present invention.

In this variation of the present invention, pin 320 has a length L greater than depth D (FIG. 4B) of the cavity formed when the mold is closed. A suitable pin length is 1560 microns and a suitable depth of the cavity is about 1500 microns. In this variation, the difference between the length of pin and the depth of the cavity (the overlap) is thus about 60 microns. While an overlap of 60 microns is acceptable, the overlap is not limited to this value. The overlap may range from 30 to 80 microns and more preferably range from about 60 to 100 microns. Still other overlap distances may be acceptable and depend on the types of materials used. However, the length of the pins should not be so long that inelastic deformation occurs when the mold is closed and the pins are compressed.

The pins may also be slightly tapered. A 1° to 8° taper is suitable and the end of the pin to contact the opposing mold section should have the smallest diameter. The tapered pin design facilitates ejection and removal of the substrate article when the mold is opened.

In operation, the contact surface of the pin(s) hit the opposing mold section surface when the mold closes. The pins compress under the clamping force of the molding machine and thus cause stress in the pin. This stress or compression is preferably within the elastic limit of the pin material. The pins are preferably made of material having a compressive yield less than the compressive yield of the opposing mold section surface because it is faster, easier and cheaper to replace pins rather than to replace the tool steel of the opposing mold section. Suitable pin materials include steels such as, but not limited to, M2 or S7 tool steel. The steels used in the pin materials may also be heat treated so that they compress before the mold sections deform. Preferably, the mold sections are tool steels which do not compress as readily as the material used for the pins. The mold sections may be formed of materials such as S7 tool steel and 420 stainless steel.

Accordingly, using the above discussed injection molding techniques, replication of microfluidic structures having flash-free through-holes is improved and parts may be made reliably at higher temperatures and pressures. This is particularly important in microfluidic devices because microfluidic devices require many microchannels, apertures and other features on small thin substrates.

Second Pin Variation

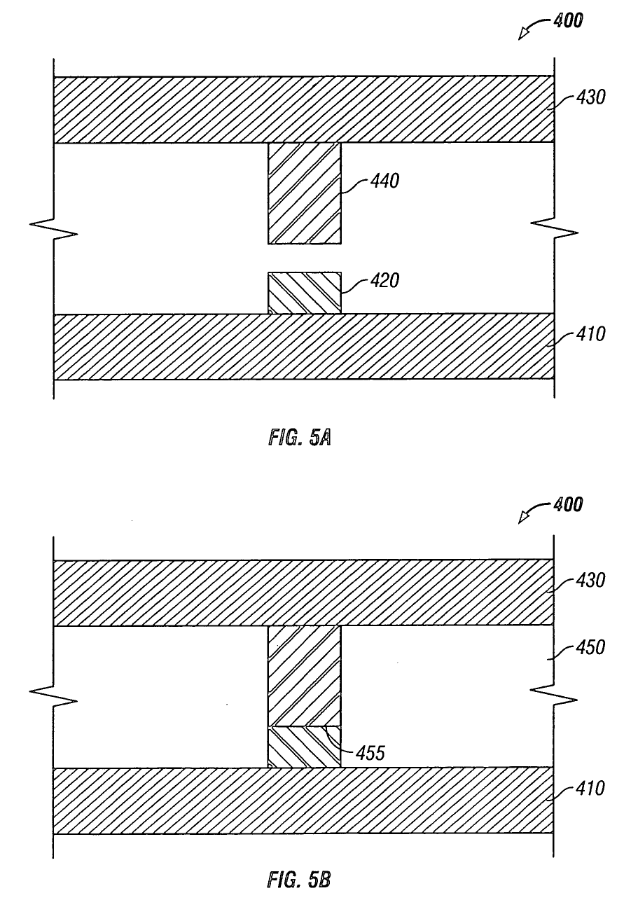

FIGS. 5A and 5B illustrate another variation of the present invention. In particular, FIGS. 5A and 5B show a partial view of a mold 400 in an open and closed configuration respectively.

Referring to FIG. 5A, mold 400 includes a first mold section or A-side 410. The A-side typically comprises the channel features and is typically an electroform. At least one short pin 420 extends from the A-side. Short pin 420 may have a length, for example, of between 0.0 and 0.125 mm. Care must be taken to ensure the short pin 420 aligns with the microchannels such that the well formed by the pin fluidly communicates with the microchannels.

The mold 400 depicted in FIG. 5A also comprises a second mold section or B-side 430. B-side section includes long pin 440. Long pin 440 may have a length, for example, of between 1 and 2 mm and preferably between 1.435 and 1.56 mm. Long pin 440 contacts the short pin 420 when the mold is closed. The long pin 440, the short pin 420, or both types of pins are compressed when the mold is closed such that material injected into cavity 450 is completely shut off from seeping into the interface 455 between the long and short pins. Flash is thus prevented from forming between the contacting surfaces of the long and short pins.

As shown in FIG. 5C, the B-side pins preferably have a larger diameter than the A-side pins 420. The B-side pins are preferably at least 50 microns larger in diameter than the A-side pins. This configuration may reduce the likelihood of air bubble formation in the vicinity of the well when the microfluidic device is in use.

This configuration also compensates for pin misalignment caused be mold shifting. As shown in FIG. 6, mold sections may shift causing the pins to misalign and create a “crescent” shaped ridge 600. In some mold machines, a ±50 micron tolerance must be planned because the pin could be ±50 micron shifted in any direction from planned alignment. However, if a molding machine has an improved tolerance, the diameters of the two types of pins may be closer in number.

The pins are preferably made of material having a compressive yield less than the compressive yield of the mold sections because it is faster, easier and cheaper to replace pins rather than to replace the tool steel of the mold section. Suitable pin materials include, but are not limited to, steels such as S7 tool steel. Additionally, both the long and the short pins may be made of the same material or different material so long as the pin materials compress at a force less than that of the mold section.

The pins may be discrete elements joined or fastened to the mold section from which they extend. The pins may also be integral with the mold section in the form of, for example, elongated cylindrical bodies. Pin combinations include but are not limited to: soft pin against hard steel surface (or nickel or nickel alloy mold plate); soft pin against soft pin; soft pin against hard pin; and hard pin against hard pin. As used hereinafter, a hard material has a higher hardness value than a soft material. As used hereinafter, a hard material has a higher yield strength than a soft material. Preferably, the mold components will have a minimum Rockwell Hardness of about 55 Rc. Mold components having a Rockwell Hardness value less than 55 Rc may be used but are less preferred because the components will ware faster, are less durable and have shorter lives.

### EXAMPLE

Substrates (“test chips”) in accordance with the present invention were formed. Portions of the test chips are shown in FIGS. 7A and 7B. In particular, FIG. 7A illustrates a flash-free through-hole viewed from the channel side or A-side surface. FIG. 7B illustrates the same feature viewed from the B-side surface.

The test chips were made from an injection molding assembly having shut off regions formed by two opposing pins as in the embodiments described above. The overlap of the opposing pins was about 60 microns. A Cincinnati Milacron Roboshot 110i injection molding machine was used to carry out injection molding with an injection pressure of about 9000 psi.

FIGS. 7A and 7B show an absence of flash in the molded article. FIGS. 7A and 7B also show a “step” at the interface where the long pin and the short pin contact one another. This ledge or step results from a difference in diameters between the two pins and may reduce the formation of air bubbles when the devices are in use. FIGS. 7A and 7B thus, in sum, illustrate a microfluidic structure having a flash-free aperture in accordance with the present invention.

All of the features disclosed in the specification (including any accompanying claims, abstract and drawings), and/or all of the steps of any method or process disclosed, may be combined in any combination, except combinations where at least some of such features and/or steps are mutually exclusive.

Each feature disclosed, in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

1. A method for forming a microfluidic structure having at least one flash-free through-hole, said method comprising:
melting a polymeric material;
injecting said polymeric material into a cavity formed by at least a first mold section and a second mold section engaged to said first mold section wherein said first mold section includes at least one pin extending a length into said cavity wherein said length is greater than a depth of said cavity such that melted polymeric material flows around said at least one pin;
cooling said polymeric material while said material is in said cavity to form a substrate having at least one flash-free through-hole;
separating said first mold section from said second mold section; and
removing said substrate from one of said first mold section and said second mold section.

2. The method of claim 1 wherein said at least one pin is integral with said first mold section.

3. The method of claim 1 wherein said at least one pin is a discrete pin joined to said first mold section.

4. The method of claim 3 wherein said discrete pin is a metal pin press fit into an opening in said first mold section.

5. The method of claim 1 wherein the length is greater than the depth of the cavity by about 60 microns.

6. The method of claim 5 wherein said first mold section comprises an electroformed portion.

7. A method for forming a microfluidic structure having at least one flash-free through-hole, said method comprising:
melting a polymeric material;
injecting said polymeric material into a cavity having a depth, said cavity formed from at least a first mold section and a second mold section positioned against said first mold section wherein said first mold section comprises a first body extending into said cavity and said second mold section comprises a second body extending into said cavity such that said first body and said second body contact one another when said first mold section and said second mold section are positioned together to form said cavity and wherein polymeric material injected into said cavity is shut off from space occupied by said first body and said second body;
cooling said polymeric material while said material is in said cavity to form a substrate;
separating said first mold section from said second mold section; and
removing said substrate from one of said first mold section and said second mold section.

8. The method of claim 7 wherein said first body and said second body combine to form a length of at least 60 microns greater than said depth of said cavity.

9. The method of claim 8 wherein said second body has a diameter greater than said first body and wherein said second body is longer than said first body.

10. An injection molding assembly for forming a microfluidic structure having at least one flash-free through-hole, said assembly comprising:
a first mold section;
a second mold section adapted to engage said first mold section such that a cavity having a depth is formed therebetween when said first mold section is engaged with said second mold section; and
at least one pin extending from at least one of said first mold section and said second mold section into said cavity wherein said at least one pin has a length greater than said depth of said cavity such that when melted polymeric material is injected into said cavity said melted polymeric material flows around said at least one pin to form a substrate having a flash-free through-hole.

11. The assembly of claim 10 wherein said at least one pin is integral with said first mold section.

12. The assembly of claim 10 wherein said at least one pin is a discrete body joined to said first mold section.

13. The assembly of claim 12 wherein said at least one pin is made of a steel and is press fit into an opening in said first mold section.

14. The assembly of claim 10 wherein the length is greater than the depth of the cavity by about 60 microns.

15. The assembly of claim 14 wherein said first mold section comprises an electroformed portion having raised surfaces to form microchannels in said substrate.

16. An injection molding assembly for forming a microfluidic substrate having at least one flash-free through-hole, said assembly comprising:
a first mold section;
a second mold section adapted to engage said first mold section such that a cavity having a depth is formed therebetween when said first mold section is engaged with said second mold section; and
at least one pin extending from said first mold section and at least one pin extending from said second mold section into said cavity such that said at least one first pin and said at least one second pin contact one another when said first mold section and said second mold section are positioned together to form said cavity and wherein polymeric material injected into said cavity is shut off from space occupied by said at least one first pin and said at least one second pin such that said at least one flash-free through-hole is formed in said substrate.

17. The assembly of claim 16 wherein said at least one pin of said first mold section and said at least one pin of said second mold section combine to form a length greater than said depth of said cavity when said cavity is formed.

18. The assembly of claim 17 wherein said length is at least 60 microns.

19. The assembly of claim 16 wherein said first mold section comprises an electroformed portion having raised surfaces to form microchannels in said substrate.

20. The assembly of claim 16 wherein said at least one pin of said first mold section has a diameter less than said at least one pin of said second mold section.

21. A substrate of a microfluidic device having at least one flash-free aperture, said substrate produced by the process comprising:
injecting a material into a cavity of an openable mold, said mold further having at least one pin extending a length into said cavity wherein said length is greater than a depth of said cavity such that said at least one pin is compressed when said mold is closed and wherein said material to fill said cavity is shut off from said space occupied by said at least one pin to form at least one flash-free through-hole in said substrate;
opening said mold; and
removing said substrate from said mold.

22. The substrate of claim 21 wherein said at least one pin is comprised of two opposing bodies.

23. The substrate of claim 21 wherein said at least one pin is a discrete body.

24. The substrate of claim 21 wherein said at least one pin is integral with said mold.

25. The substrate of claim 21 wherein said length is greater than said depth by at least about 60 microns.

26. The substrate of claim 21 wherein said mold comprises an electroformed portion having raised surfaces to form said at least one microchannel.

27. A microfluidic device comprising:
a substrate comprising at least one flash-free aperture produced by the method recited in any one of claims 1 to 9; and
a plate bonded to the substrate such that a reservoir is formed at said at least one flash-free aperture.

28. The assembly of claim 17 wherein only one of said pins compresses a distance when said cavity is formed.

29. The assembly of claim 17 wherein each and every one of said pins compresses at least a distance when said cavity is formed.

30. The assembly of claim 10 wherein the length is greater than the depth of the cavity by 10 to 100 microns.

31. The assembly of claim 10 wherein the length is greater than the depth of the cavity by 30 to 80 microns.
